(19) United States
(12) Patent Application Publication
(10) Pub. No.: US 2021/0072884 A1
(43) Pub. Date: Mar. 11, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Yohei UCHIUMI, Kanagawa (JP)

(73) Assignee: FUJI XEROX CO., LTD., Tokyo (JP)

(21) Appl. No.: 16/749,169

(22) Filed: Jan. 22, 2020

(30) Foreign Application Priority Data
Sep. 10, 2019 (JP) 2019-164918

(51) Int. Cl. G06F 3/0484; G06F 3/0482; G06F 9/451

(52) U.S. Cl. CPC G06F 3/04845; G06F 9/451; G06F 3/0482

(57) ABSTRACT

An information processing apparatus includes a processor configured to receive a display instruction to display a display window from an operator. The processor is also configured to automatically display the display window on a display at a basic display position determined according to a predetermined rule, in response to determining that movement history information of a plurality of movement instructions of a display window by an operator does not satisfy a first condition, and to automatically display the display window on the display at a changed position that is offset from the basic display position, in response to determining that the movement history satisfies the first condition.

### CROSS-REFERENCE TO RELATED APPLICATION(S)

This application is based on and claims priority under 35 USC 119 from Japanese Patent Application No. 2019-164918 filed on Sep. 10, 2019.

### BACKGROUND

### (i) Technical Field

The present invention relates to an information processing apparatus and a non-transitory computer readable medium.

### (ii) Related Art

In the related art, in an application that operates on an information processing apparatus, a display window such as a context menu or a pop-up message may be newly displayed on a display according to an operator's display instruction.

JP-T-2011-526033 discloses that in an application for editing an electronic document, a display instruction is input when an operator clicks the right button of a mouse, and a region menu that includes various buttons for inputting various instructions to the application is displayed close to a mouse cursor.

### SUMMARY

When the display window is displayed according to a display instruction from an operator, the display window is displayed at a basic display position determined according to a predetermined rule. For example, when the display instruction is input by clicking the right button of the mouse, the display window is displayed such that the position of the mouse cursor when the right button of the mouse is clicked becomes the upper left corner of the display window.

However, the position where the display window is desired to be displayed may differ depending on an operator.

Aspects of non-limiting embodiments of the present disclosure relate to an information processing apparatus that displays a display window on a display according to a display instruction from an operator, the information processing apparatus displaying the display window at a position suitable for the operator, rather than a basic display position determined according to a predetermined rule.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to display a display window on a display according to a display instruction from an operator, and move the display window according to a movement instruction from the operator. Upon receipt of the display instruction from the operator, the processor displays the display window at a changed display position that is changed from a basic display position determined according to a predetermined rule, based on movement history information indicating a past movement of the display window according to the movement instruction from the operator.

### BRIEF DESCRIPTION OF THE DRAWINGS

Exemplary embodiment(s) of the present disclosure will be described in detail based on the following figures, wherein:

FIG. 1 is a schematic configuration diagram of an information processing apparatus according to an exemplary embodiment of the present disclosure;

FIG. 2 is a view illustrating a state where a toolbox is displayed at a basic display position;

FIG. 3 is a view illustrating an example of contents of a movement history DB;

FIG. 4 is a view illustrating a state where a toolbox is displayed at a changed display position;

FIG. 5 is a view illustrating an example of a distribution of movement data and clusters;

FIG. 6 is a view illustrating an edge of a screen hidden by the toolbox displayed at the changed display position;

FIG. 7 is a view illustrating a state where a toolbox is displayed at a corrected changed display position;

FIG. 8 is a view illustrating a state where a toolbox is divided and displayed; and

FIG. 9 is a flowchart illustrating a flow of a process performed by the information processing apparatus according to the exemplary embodiment.

### DETAILED DESCRIPTION

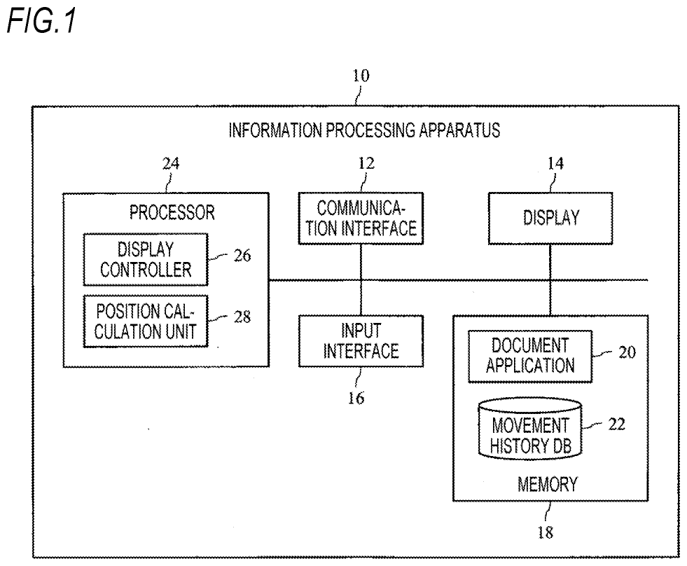

FIG. 1 is a schematic configuration diagram of an information processing apparatus 10 according to an exemplary embodiment. In the present exemplary embodiment, the information processing apparatus 10 is a personal computer. However, the information processing apparatus 10 may be another apparatus as long as the apparatus has the functions to be described herein below. For example, the information processing apparatus 10 may be a portable terminal such as a tablet terminal or a smartphone.

A communication interface 12 includes, for example, a wired or wireless LAN adapter. The communication interface 12 exhibits a function to communicate with other devices via a communication line such as a LAN or the Internet. For example, an electronic document may be received from other devices via the communication interface 12.

A display 14 includes, for example, a liquid crystal display. The display 14 displays various screens. Especially, the display 14 displays a screen of a document application 20 to be described later.

An input interface 16 includes, for example, a mouse, a keyboard, or a touch panel. The input interface 16 is used for inputting a user's instruction to the information processing apparatus 10.

A memory 18 includes, for example, a hard disk, a solid state drive (SSD), an embedded multimedia card (eMMC), a ROM, or a RAM. The memory 18 may be provided separately from a processor 24 to be described later, or at least a portion of the memory 18 may be provided inside the processor 24. The memory 18 stores an information processing program for operating each unit of the information processing apparatus 10.

In addition, as illustrated in FIG. 1, the document application 20 is installed in the memory 18. The document application 20 may operate on the information processing apparatus 10, displays an electronic document stored in the memory 18, and edits the electronic document.

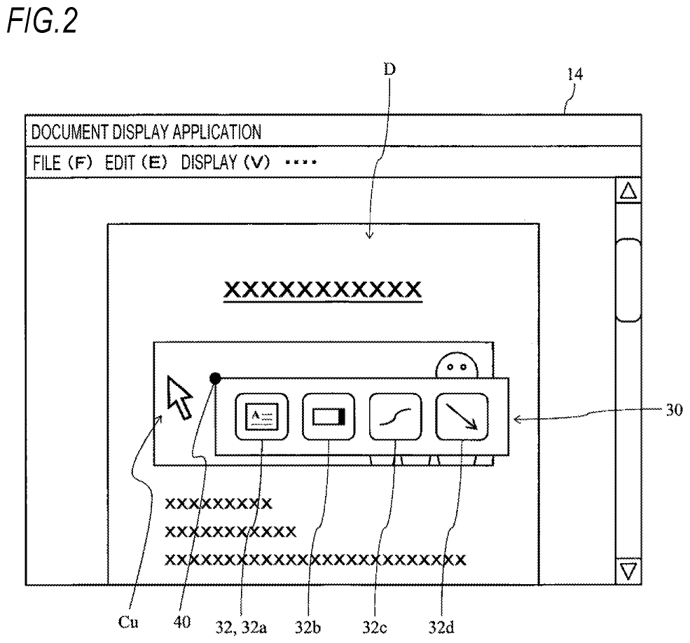

FIG. 2 is a view illustrating an example of the screen of the display 14 when the document application 20 is executed. When the document application 20 is executed, a selected electronic document D is displayed within the window of the document application 20.

In a case where the document application 20 is selected as an operation target (in other words, when the document application 20 is focused), a toolbox 30 is newly displayed as a display window on the display 14 when an operator (that is, a user) inputs a display instruction from the input interface 16.

The toolbox 30 includes plural types of buttons 32 for performing various types of editing on the electronic document D opened by the document application 20. In the example of FIG. 2, the toolbox 30 includes a text button 32a for adding a text box to the electronic document D, a sticky note button 32b for adding a sticky note to the electronic document D, a curve button 32c for adding a curve to the electronic document D, and an arrow button 32d for adding an arrow to the electronic document D. In addition, the toolbox 30 may include other types of buttons 32.

In the layer structure of the screen, the toolbox 30 is displayed on the front side (that is, the fore side) of the window of the document application 20 or the electronic document D, and is opaque. Alternatively, the toolbox 30 is displayed on the foremost layer in the layer structure of the screen. Thus, when the toolbox 30 is displayed, the toolbox 30 hides the screen of the document application 20 that is originally displayed at the position where the toolbox 30 is displayed.

In the present exemplary embodiment, the toolbox 30 is the display window displayed on the display 14 according to the user's display instruction. However, the display window may be another window as long as the window is displayed on the front side of the window of the document application 20 or the electronic document D and is opaque. For example, the display window may be a context menu that includes various command input menu buttons. In addition, the display window may be, for example, a window that does not include buttons to be operated by a user, such as a message window including message texts to a user.

In the present exemplary embodiment, the user's display instruction to display the toolbox 30 as a display window is input to the information processing apparatus 10 in the manner that the user clicks the right button of the mouse included in the input interface 16. That is, when the user clicks the right button of the mouse, the toolbox 30 is displayed on the display 14 as illustrated in FIG. 2. The operation of inputting the display instruction to display the display window may be another operation. The user may click the left button of the mouse, press the wheel of the mouse, or press a specific key included in the keyboard. In addition, the operation of inputting the user's display instruction to display the display window may be an operation of moving a mouse cursor Cu that moves on the display 14, to a specific position according to an operation of the mouse. For example, when the mouse cursor Cu is moved to a position on an image or texts included in the electronic document D, the document application 20 may recognize that the movement of the mouse cursor Cu indicates a display instruction from the user, and display a display window (for example, a message window).

In principle, the toolbox 30 is displayed at a basic display position 40 determined according to a predetermined rule. In the present exemplary embodiment, the basic display position 40 is the position (for example, coordinates) of the mouse cursor Cu when the user inputs a display instruction by clicking the right button of the mouse as the display instruction, that is, the position corresponding to the input position of the display instruction from the user. Specifically, as illustrated in FIG. 2, the basic display position 40 is the position moved by a predetermined distance (that is, a predetermined number of pixels) in the x-axis direction from the position of the mouse cursor Cu when the user inputs the display instruction, and the toolbox 30 is displayed such that a reference point in the toolbox 30 (the upper left corner in the present exemplary embodiment) matches the basic display position 40. In this way, when the toolbox 30 is displayed based on the basic display position 40 as a reference, it is expressed that the toolbox 30 is displayed at the basic display position 40. Meanwhile, coordinates of each pixel in the display 14 are set such that the pixel of the upper left corner has an x-axis coordinate of 1 and a y-axis coordinate of 1, the pixel of the right corner has the largest x-axis coordinate, and the pixel of the lower corner has the largest y-axis coordinate. In addition, the positional relationship between the input position of the display instruction and the basic display position 40 may be another positional relationship. For example, the input position of the display instruction and the basic display position 40 may match each other.

In the present exemplary embodiment, the basic display position 40 is defined as a relative position to the input position of the display instruction. For example, the basic display position 40 is defined as (relative position in x-axis direction, relative position in y-coordinate direction)=(15, 0). This indicates that the basic display position 40 is a position moved by 15 pixels in the x-axis direction and by 0 pixel in the y-axis direction, from the input position of the display instruction. The relative expression (such as (15, 0)) of the basic display position 40 to the input position of the display instruction will be referred to as a relative basic position.

As described above, in the present exemplary embodiment, the basic display position 40 is determined by the relative position to the input position of the display instruction, and varies according to the input position of the display instruction. However, the predetermined rule for determining the basic display position 40 may instruct a specific position on the display 14. In this case, in principle, the toolbox 30 is always displayed at a fixed position, regardless of the input position of the user's display instruction.

The toolbox 30 displayed at the basic display position 40 is movable on the display according to a movement instruction from the user. In the present exemplary embodiment, the user may input an instruction to move the toolbox 30, by performing an operation of moving the mouse cursor Cu to a position other than the buttons 32 of the toolbox 30 and moving the mouse while pressing the left button of the mouse (that is, drag operation). As a result, the toolbox 30 moves to a position corresponding to the drag operation. In addition, the operation of inputting the instruction to move the toolbox 30 may be another operation.

Meanwhile, in the present exemplary embodiment, the document application 20 is installed in the memory 18, and the process according to the present exemplary embodiment is executed on the document application 20. However, another application (for example, an image processing application) may be installed in the memory 18 as long as a display window is newly displayed according to a display instruction from a user, and the process according to the present exemplary embodiment may be executed by the corresponding application.

Referring back to FIG. 1, the memory 18 further stores a movement history DB (database) 22. The movement history DB 22 stores movement history information indicating the past movement of the toolbox 30 in the document application 20, for each user.

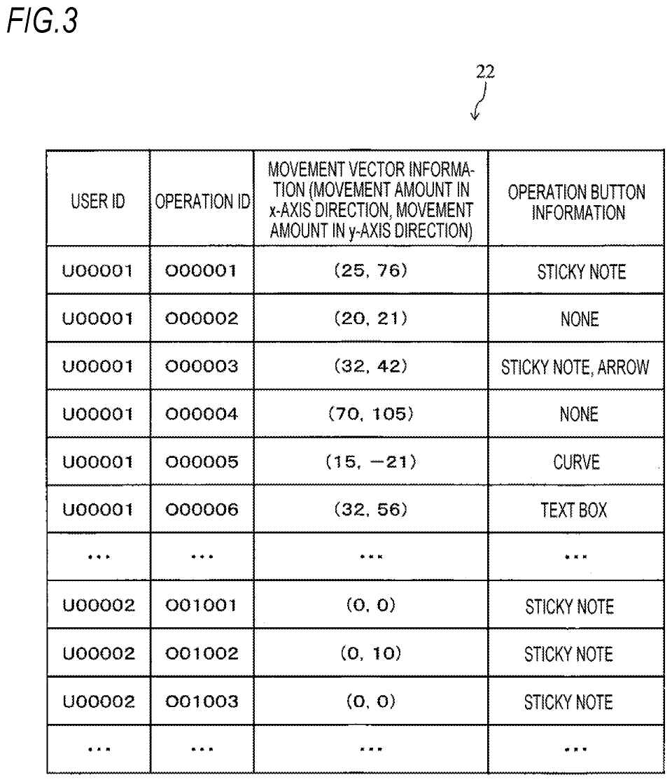

FIG. 3 is a view illustrating an example of the contents of the movement history DB 22. As illustrated in FIG. 3, in the movement history DB 22, a user ID, an operation ID, movement vector information, and operation button information are associated with each other. A set including a user ID, an operation ID, movement vector information, and operation button information will be referred to as movement data. In the document application 20, whenever the user displays the toolbox 30 and the user moves the toolbox 30, a processor 24 to be described later accumulates and stores the movement data in the movement history DB 22.

The user ID is information for identifying a user who moves the toolbox 30. In the present exemplary embodiment, a user authentication process (that is, a login process) is required when the information processing apparatus 10 is started, and the user who operates the document application 20, that is, the user who moves the toolbox 30 may be specified by the user authentication process.

The operation ID is information for identifying a movement operation performed by the user, and is automatically acquired by the processor 24 each time the user moves the toolbox 30.

The movement vector information indicates a movement direction and a movement amount of the toolbox 30 from the basic display position 40. The movement vector information is represented as (movement amount in x-axis direction, movement amount in y-axis direction). For example, the uppermost record (that is, movement data) of the table illustrated in FIG. 3 indicates that the toolbox 30 is moved to a position 25 pixels apart in the x-axis direction and 76 pixels apart in the y-axis direction, from the basic display position 40. Meanwhile, in the present exemplary embodiment, since the basic display position 40 indicates the position of the upper left corner of the toolbox 30, the position of the upper left corner of the moved toolbox 30 becomes the position moved by 25 pixels in the x-axis direction and by 76 pixels in the y-axis direction from the basic display position 40.

The operation button information indicates a button 32 operated by the user after the user moves the toolbox 30, among the buttons 32 included in the toolbox 30. When the user does not operate the buttons 32 after moving the toolbox 30, the operation button information indicates “none”. In addition, when the user operates plural buttons 32 after moving the toolbox 30, information indicating the plural operated buttons 32 is stored as the operation button information.

The user may not move the toolbox 30 from the basic display position 40. In this case, while no movement data is stored in the movement history DB 22, the processor 24 counts the number of times that the user displays the toolbox 30, and holds the counted number of times in the movement history DB 22 for each user. Since the number of times that each user moves the toolbox 30 can be grasped from the number of movement data, the number of times that each user displays the toolbox 30 is held so that the number of movements times of the toolbox 30 relative to the number of display times of the toolbox 30, that is, the execution frequency of the movement operation can be grasped.

Meanwhile, in the present exemplary embodiment, the movement history DB 22 is stored in the memory 18 of the information processing apparatus 10. However, the movement history DB 22 may be stored in another apparatus accessible from the information processing apparatus 10.

The processor 24 is a broad-sense processing apparatus, and includes at least one of a general-purpose processing apparatus (for example, a central processing unit (CPU)) or a dedicated processing apparatus (for example, a graphics processing unit (GPU), an application specific integrated circuit (ASIC), a field programmable gate array (FPGA) or a programmable logic device). The processor 24 may not be implemented by a single processing apparatus, but may be implemented by a cooperation of plural processing apparatuses which exist physically apart from each other. The processor 24 exhibits functions of a display controller 26 and a position calculation unit 28 as illustrated in FIG. 1 in cooperation with information processing programs stored in the memory 18.

The display controller 26 controls the display of various screens on the display 14. Specifically, the display controller 26 controls the display of, for example, the window of the document application 20, the electronic document D, and the mouse cursor Cu as described above. Further, the display controller 26 performs a control to display the toolbox 30 according to a display instruction from the user. Further, the display controller 26 performs a control to display the toolbox 30 at a position after a movement of the toolbox 30 according to a movement instruction from the user.

As described above, the display controller 26 is able to display the toolbox 30 at the basic display position 40, and is also able to display the toolbox 30 at a changed display position that is calculated by the position calculation unit 28 to be described later, according to a display instruction from the user. In the present exemplary embodiment, upon receipt of a display instruction from the user, the display controller 26 displays the toolbox 30 at a changed display position when the number of movement data accumulated for the corresponding user in the movement history DB 22 is equal to or more than a predetermined number (for example, fifty), and displays the toolbox 30 at the basic display position 40 when the number of movement data accumulated for the corresponding user in the movement history DB 22 is less than the predetermined number. In addition, it may be switched by a user setting whether to display the toolbox 30 at the basic display position 40 or at a changed display position to be described later.

The position calculation unit 28 calculates a changed display position based on the movement history DB 22. In the present exemplary embodiment, the position calculation unit 28 calculates the changed display position by the process to be described hereinafter. First, when an instruction to display the toolbox 30 is received from the user who operates the document application 20, the position calculation unit 28 specifies the user ID of the corresponding user based on authentication information of the user. Then, the position calculation unit 28 refers to the movement history DB 22 and extracts movement data corresponding to the specified user ID.

Next, the position calculation unit 28 calculates a changed display position based on movement vector information of the extracted movement data. The position calculation unit 28 calculates a position moved from the basic display position 40 in a movement direction and a movement amount that are calculated based on the movement vector information of the extracted movement data, as a changed display position.

In the present exemplary embodiment, a relative changed position that indicates a relative position of the changed display position to the input position of the display instruction is calculated by Equation (1) below.

Relative changed position=relative basic position+(representative movement vector)×(execution frequency of movement operation) (1)

The representative movement vector indicates a representative movement direction and a representative movement amount that are calculated from movement vector information of respective movement data extracted from the movement history DB 22. In the present exemplary embodiment, the representative movement vector is represented as (movement amount in x-axis direction, movement amount in y-axis direction). In the present exemplary embodiment, the representative movement vector is calculated by (average value of movement amounts of respective extracted movement data in x-axis direction, average value of movement amounts of respective extracted movement data in y-axis direction). Assuming that the movement history DB 22 stores six movement data corresponding to operation IDs “O00001” to “O00006” as illustrated in FIG. 3, an average of the movement amounts in the x-axis direction for the user indicated by the user ID “U00001” becomes (25+20+32+70+15+32)/6=32.3, and an average of movement amounts in the y-axis direction for the same user becomes (76+21+42+105+(−21)+56)/6=46.5. Thus, the representative movement vector becomes (32.3, 46.5).

The execution frequency of the movement operation is the number of times that the user moves the toolbox 30, relative to the number of times that the user displays the toolbox 30. Assuming that the user indicated by the user ID “U00001” displays the toolbox 30 150 times and moves the toolbox 30 45 times, the execution frequency of the movement operation performed by the user indicated by the user ID “U00001” becomes 45/150=0.3. As described above, since the execution frequency of the movement operation is stored for each user in the movement history DB 22, the position calculation unit 28 is able to acquire the execution frequency of the user's movement operation by referring to the movement history DB 22.

In addition, when the relative basic position is represented as (15, 0), the relative changed position becomes (15+32.3×0.3, 0+46.5×0.3), that is, (25, 14), based on Equation (1). Meanwhile, in the example described above, the second decimal place is rounded off in calculating the average of the movement amounts, and the first decimal place is rounded off in calculating the relative changed position. However, the second decimal place or the first decimal place may be rounded up or down.

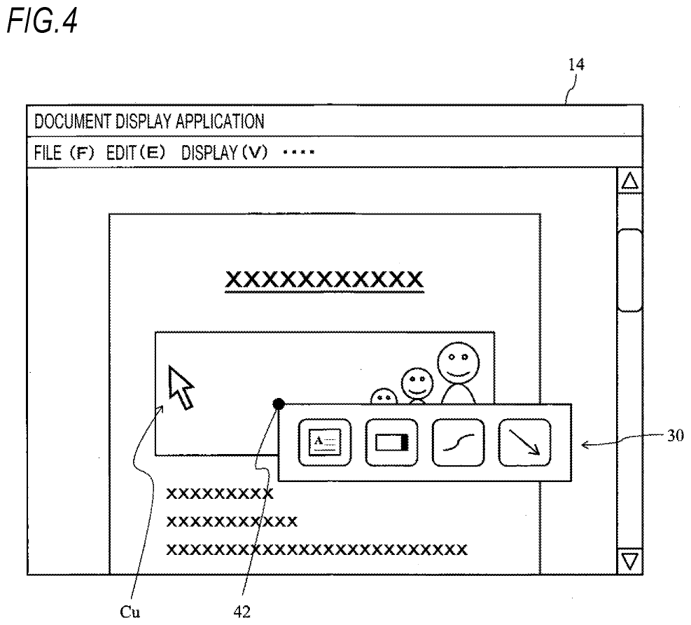

The display controller 26 is able to display the toolbox 30 at the changed display position indicated by the relative changed position calculated by the position calculation unit 28. Specifically, the changed display position becomes the position moved by the amount indicated by the relative changed position from the input position of the display instruction. In the example described above, as illustrated in FIG. 4, a changed display position 42 becomes the position moved by 25 pixels in the x-axis direction and by 14 pixels in the y-axis direction from the position of the mouse cursor Cu when the display instruction is input, and the display controller 26 displays the toolbox 30 such that the reference point in the toolbox 30 (the upper left corner of the toolbox 30 in the present exemplary embodiment) matches the changed display position 42. In this way, when the toolbox 30 is displayed based on the changed display position 42 as a reference, it is expressed that the toolbox 30 is displayed at the changed display position 42.

The representative movement vector in Equation (1) may be calculated by other methods. For example, the representative movement vector may be calculated by (the mode of movement amounts of respective extracted movement data in the x-axis direction, the mode of movement amounts of respective extracted movement data in the y-axis direction) or (the median value of movement amounts of respective extracted movement data in the x-axis direction, the median value of movement amounts of respective extracted movement data in the y-axis direction).

In addition, for example, the position calculation unit 28 may plot plural movement data stored in the movement history DB 22 on a two-dimensional map with an x axis and a y axis according to movement vector information of the plural movement data, and specify one or more clusters in which movement data are clustered on the two-dimensional map, and calculate barycentric coordinates of one cluster selected from the one specified cluster or the plural specified clusters as the representative movement vector.

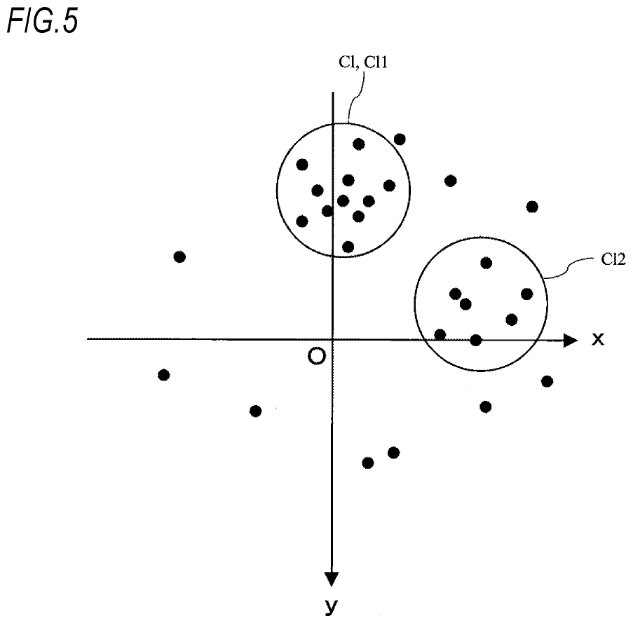

For example, it is assumed that the position calculation unit 28 plots plural movement data stored in the movement history DB 22 on a two-dimensional map with an x axis and a y axis as illustrated in FIG. 5. In FIG. 5, one black circle corresponds to one movement data. Then, it is assumed that the position calculation unit 28 specifies two clusters Cl1 and Cl2. Meanwhile, since a known technique may be used as the method of specifying a cluster Cl, detailed description thereof will be omitted herein. In the present exemplary embodiment, when plural clusters Cl are specified, the position calculation unit 28 selects a cluster Cl that includes a relatively large number of movement data. In the example of FIG. 5, upon comparing the clusters Cl1 and Cl2, the cluster Cl1 includes more movement data than those of the cluster Cl2, and thus, the position calculation unit 28 selects the cluster Cl1. Meanwhile, the method of selecting a cluster Cl may be another method. Then, the position calculation unit 28 calculates barycentric coordinates of the cluster Cl1 as the representative movement vector.

For example, when a certain user frequently moves the displayed toolbox 30 downward by a certain amount from the basic display position 40, it is understood that the position moved downward by a certain amount from the basic display position 40 is more suitable for the user as a position where the toolbox 30 is displayed. In the present exemplary embodiment, as described above, the changed display position 42 is calculated by the position calculation unit 28 based on the movement history DB 22 indicating the past movement of the toolbox 30 by the user in the document application 20. Thus, for example, when the user described above inputs a display instruction in the circumstance where the user frequently moved the toolbox 30 downward from the basic display position 40 in the past, the toolbox 30 is displayed at the changed display position 42 which is the position moved downward from the basic display position 40 by a certain amount. As a result, the user can display the toolbox 30 at the position suitable for the user without moving the toolbox 30.

It may also be considered that a difference occurs in tendency of a movement direction or a movement amount of the toolbox 30 depending on the basic display position 40. For example, in a case where the left side of the screen from the center thereof is the basic display position 40, that is, the toolbox 30 is displayed on the left side of the screen, the frequency that a user moves the toolbox 30 to the left side may be relatively high, and in a case where the right side of the screen from the center thereof is the basic display position 40, that is, the toolbox 30 is displayed on the right side of the screen, the frequency that the user moves the toolbox 30 to the right side may be relatively high.

According to these cases, the movement data accumulated in the movement history DB 22 may include basic display position information indicating the basic display position 40, that is, the position where the toolbox 30 is displayed. Then, in calculating the changed display position 42, the position calculation unit 28 may refer to the basic display position information of each movement data in the movement history DB 22, and extract only movement data that corresponds to a position where the user inputs an instruction to display the toolbox 30 at this time. For example, when the screen of the display 14 is conceptually divided into plural areas and a position where the user inputs a display instruction at this time is a first area among the plural areas, the position calculation unit 28 may extract only movement data of which basic display position information indicates a position in the first area from the movement history DB 22, to calculate the changed display position 42.

As described above, since the toolbox 30 is displayed on the front side in the layer structure of the screen and is opaque, the screen originally displayed at the position where the toolbox 30 is displayed is hidden when the toolbox 30 is displayed. Here, it may not be appropriate if the toolbox 30 hides a portion with a relatively large amount of information in the screen displayed on the display 14.

Thus, the position calculation unit 28 may correct the display position of the toolbox 30, by a neighborhood search process to be described later, to prevent as much as possible the displayed toolbox 30 from hiding a portion with a relatively large amount of information in the screen displayed on the display 14. It may be switchable according to, for example, a user setting, whether to perform the neighborhood search process. Meanwhile, the neighborhood search process will be described hereinafter for a case where the display position of the toolbox 30 is further corrected from the changed display position 42. However, the display position of the toolbox 30 may be corrected from the basic display position 40, by the neighborhood search process.

In the present exemplary embodiment, the amount of information in the screen displayed on the display 14 is estimated based on the amount of edges of the screen. That is, it is assumed that a portion with a relatively large amount of edges has a relatively large amount of information, and a portion with a relatively small amount of edges has a relatively small amount of information. An edge refers to a pixel having a pixel value (luminance value or color value) equal to or larger than a predetermined value, in adjacent pixels, and the amount of edges refers to the number of edge pixels recognized as edges. Further, the amount of edges may be calculated in consideration of a difference in pixel value between each edge pixel and an adjacent pixel thereof.

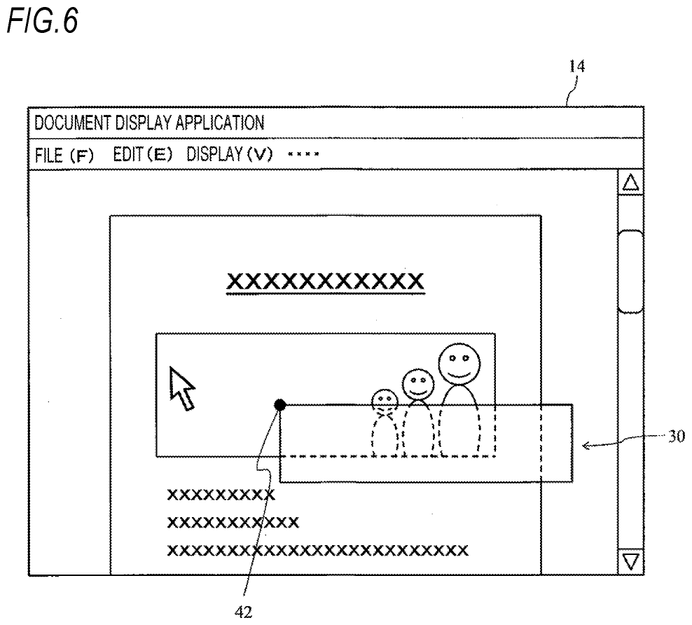

FIG. 6 represents edge pixels of the screen that are hidden when the toolbox 30 is displayed at the changed display position 42. The pixels indicated by dashed lines in FIG. 6 are the edge pixels.

The position calculation unit 28 calculates the amount of edges of the screen that are hidden by the display of the toolbox 30 when the toolbox 30 is displayed, for each of the changed display position 42 and one neighboring position or plural neighboring positions of the changed display position 42. Meanwhile, the neighboring position of the changed display position 42 is, for example, a position that belongs to a range of ±5 pixels in the x-axis direction and ±5 pixels in the y-axis direction, from the changed display position 42. Meanwhile, the edge pixels taken into account for the amount of edges calculated by the position calculation unit 28 may be limited to the pixels included in the window of the document application 20, rather than the pixels of the entire screen.

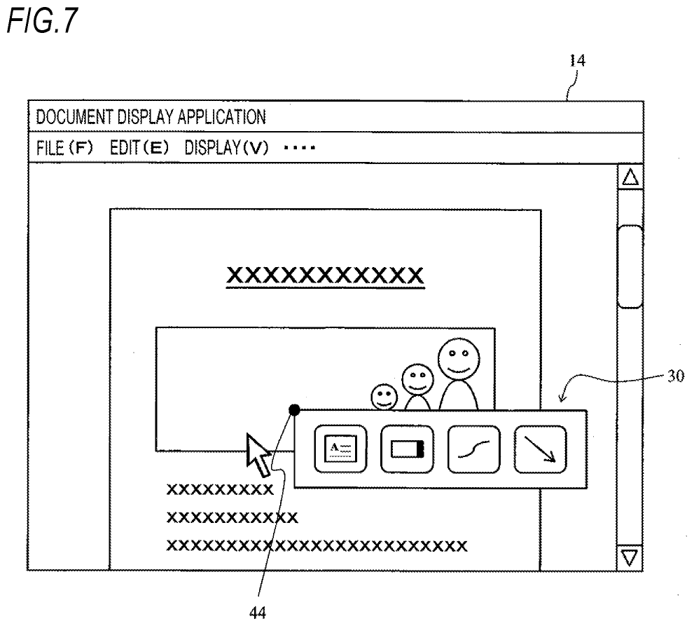

Then, the position calculation unit 28 compares the amount of edges calculated at the respective positions, and specifies a position with the smallest amount of edges. The specified position will be referred to as a corrected changed display position. Then, as illustrated in FIG. 7, the display controller 26 displays the toolbox 30 such that the reference point in the toolbox 30 (the upper left corner of the toolbox 30 in the present exemplary embodiment) matches a corrected changed display position 44. In this way, when the toolbox 30 is displayed based on the corrected changed display position 44 as a reference, it is expressed that the toolbox 30 is displayed at the corrected changed display position 44.

The changed display position 42 is a position calculated based on the movement history DB 22, that is, a position suitable for a user when the toolbox 30 is displayed. Accordingly, it may not be appropriate if the corrected changed display position 44 calculated by the neighborhood search process is largely apart from the changed display position 42.

Thus, the position calculation unit 28 may determine the corrected changed display position 44 in consideration of not only the amount of edges of the screen that are hidden by the display of the toolbox 30, but also the distance from the changed display position 42. Specifically, the position calculation unit 28 may calculate an index value that increases as the amount of edges of the screen that are hidden by the display of the toolbox 30 increases, and increases as the distance from the changed display position 42 increases, for each of the changed display position 42 and one neighboring position or plural neighboring positions of the changed display position 42, and determine a position where the index value is smallest to be the corrected changed display position 44.

In the present exemplary embodiment, the position calculation unit 28 calculates the index value described above using Equation (2) below.

Index value=(amount of edges hidden by toolbox 30)×(distance coefficient) (2)

The distance coefficient is a coefficient that increases as the distance from the changed display position 42 increases. Specifically, the distance coefficient is calculated using Equation (3) below.

Distance coefficient=0.2×N+1.0 (3)

In Equation (3), N represents the distance from the changed display position 42.

Meanwhile, as for the method of calculating the index value, the index value may be calculated by another method as long as the index value increases as the amount of edges of the screen that are hidden by the display of the toolbox 30 increases, and increases as the distance from the changed display position 42 increases.

The corrected changed display position 44 is determined based on the index value described above, so that the corrected changed display position 44 can be prevented from being apart from the changed display position 42, as compared with a case where the corrected changed display position 44 is determined simply based on the amount of edges of the screen that are hidden by the toolbox 30.

When the toolbox 30 includes the plural buttons 32 as in the present exemplary embodiment, there may be a relationship between each of the plural movement directions of the toolbox 30 and the type of a button 32 operated after the movement of the toolbox 30. For example, the relationship may occur when a specific user frequently operates the text button 32a (see FIG. 2) when the toolbox 30 is moved upward, and frequently operates the curve button 32c when the toolbox 30 is moved rightward.

In this case, it may be preferable for the corresponding user that the text button 32a is displayed on the upper side of the basic display position 40, and the curve button 32c is displayed on the right side of the basic display position 40. Thus, when there is a relationship between the respective movement directions of the toolbox 30 and the types of buttons 32 operated after the movement of the toolbox 30, the position calculation unit 28 may calculate plural changed display positions 42, and the display controller 26 may divide and display the toolbox 30 at the plural changed display positions 42.

Specifically, when determining, based on the movement vector information and the operation button information in the movement history DB 22, that a user who inputs the display instruction of the toolbox 30 tends to operate a first button after moving the toolbox 30 in a first movement direction, and tends to operate a second button after moving the toolbox 30 in a second movement direction, the position calculation unit 28 determines the position moved in the first movement direction from the basic display position 40 to be a first changed display position 42, and determines the position moved in the second movement direction from the basic display position 40 to be a second changed display position 42. Then, the display controller 26 displays a first divided window including the first button at the first changed display position 42, and displays a second divided window including the second button at the second changed display position 42.

In the present exemplary embodiment, the position calculation unit 28 determines the first and second changed display positions 42 as follows. As illustrated in FIG. 5, the position calculation unit 28 plots plural movement data stored in the movement history DB 22 on a two-dimensional map with an x axis and a y axis, and specifies plural clusters Cl. Then, for each cluster Cl, the position calculation unit 28 refers to the operation button information of the movement data included in the cluster Cl, and determines whether there is a button 32 with a high use frequency. For example, the position calculation unit 28 determines whether there is a button 32 of which number of times of use, that is, use frequency is equal to or more than a predetermined value, using the movement data included in each cluster Cl as the number of parameters. Then, when the plural clusters Cl have buttons 32 with a high use frequency, respectively, and the types of the buttons 32 with the high use frequency in the plural clusters Cl are different from each other, the position calculation unit 28 calculates barycentric coordinates of each of the plural clusters Cl, and determines the plural obtained barycentric coordinates to be plural representative movement vectors. The plural changed display positions 42 are determined by Equation (1) described above using the plural representative movement vectors specified as described above.

For example, in the example of FIG. 5, when the text button 32a and the sticky note button 32b are buttons 32 with a high use frequency in movement data included in the cluster Cl1, and the curve button 32c and the arrow button 32d are buttons 32 with a high use frequency in movement data included in the cluster Cl2, the position calculation unit 28 calculates a first representative movement vector based on the barycentric coordinates of the cluster Cl1, and calculates a first relative changed position based on the first representative movement vector using Equation (1). Further, the position calculation unit 28 calculates a second representative movement vector based on the barycentric coordinates of the cluster Cl2, and calculates a second relative changed position based on the second representative movement vector using Equation (1).

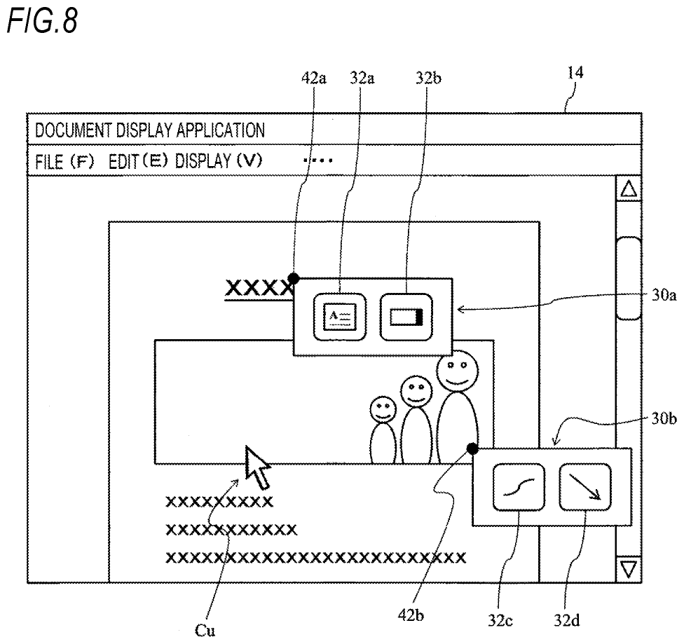

Then, as illustrated in FIG. 8, the display controller 26 determines the position moved by the amount indicated by the first relative changed position from the input position of the display instruction of the toolbox 30, that is, from the position of the mouse cursor Cu when the display instruction is input, to be a first changed display position 42a, and displays a first divided window 30a including the text button 32a and the sticky note button 32b at the first changed display position 42a. Further, the display controller 26 determines the position moved by the amount indicated by the second relative changed position from the input position of the display instruction of the toolbox 30, to be a second changed display position 42b, and displays a second divided window 30b including the curve button 32c and the arrow button 32d at the second changed display position 42b.

Meanwhile, in the example of FIG. 8, the two divided windows 30a and 30b are displayed. However, three or more changed display positions 42 may be specified, and three or more divided windows may be displayed. In addition, the neighborhood search process described above may be performed for each of the first divided window 30a and the second divided window 30b, so as to calculate the corrected changed display position 44 for each of the first divided window 30a and the second divided window 30b, and display the first divided window 30a and the second divided window 30b at the corrected changed display positions 44.

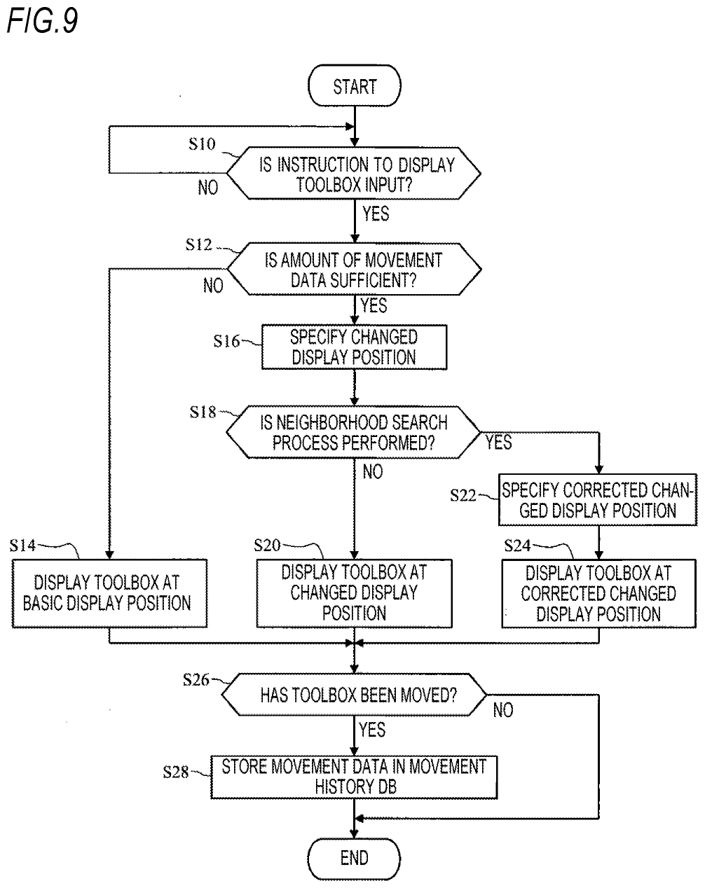

Hereinafter, the flow of the process of the information processing apparatus 10 according to the present exemplary embodiment will be described along the flowchart illustrated in FIG. 9.

In step S10, the position calculation unit 28 determines whether an instruction to display the toolbox 30 is input from the user. The position calculation unit 28 waits until a display instruction is input, and proceeds to step S12 when it is determined that a display instruction is input.

In step S12, the position calculation unit 28 specifies the user ID of the user who inputs the display instruction in step S10, refers to the movement history DB 22, and determines whether a predetermined number or more of movement data are accumulated for the corresponding user ID. When it is determined that the movement data accumulated for the corresponding user ID in the movement history DB 22 are less than the predetermined number, the process proceeds to step S14.

In step S14, the display controller 26 displays the toolbox 30 at the basic display position 40 that is a position corresponding to the position where the display instruction is input.

When it is determined that the movement data accumulated for the corresponding user ID in the movement history DB 22 are equal to or more than the predetermined number, the process proceeds to step S16 from step S12.

In step S16, the position calculation unit 28 specifies the changed display position based on the movement history DB 22 through the process described above.

In step S18, the position calculation unit 28 determines whether to perform the neighborhood search process. When it is set by a user setting not to perform the neighborhood search process, the process proceeds to step S20.

In step S20, the display controller 26 displays the toolbox 30 at the changed display position 42 specified in step S16.

When it is set by a user setting to perform the neighborhood search process, the process proceeds to step S22 from step S18.

In step S22, the position calculation unit 28 performs the above-described neighborhood search process, and specifies the corrected changed display position 44.

In step S24, the display controller 26 displays the toolbox 30 at the corrected changed display position 44 specified in step S22.

In step S26, the processor 24 determines whether the toolbox 30 displayed in step S14, S20, or S24 has been moved by the user. When it is determined that the toolbox 30 has been moved, the process proceeds to step S28, and when it is determined that the toolbox 30 has not been moved, step S28 is bypassed, and the process is ended.

In step S28, the processor 24 stores the movement data corresponding to the movement of the toolbox 30 by the user, in the movement history DB 22.

While the exemplary embodiment according to the present disclosure has been described, the present disclosure is not limited to the exemplary embodiment, and various modifications may be made without departing from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a processor configured to
receive a display instruction to display a display window from an operator;
automatically display the display window on a display at a basic display position determined according to a predetermined rule, in response to determining that movement history information of a plurality of movement instructions of a display window by the operator does not satisfy a first condition; and
automatically display the display window on the display at a changed position that is offset from the basic display position, in response to determining that the movement history satisfies the first condition.

2. The information processing apparatus according to claim 1, wherein
the movement history information comprises information indicating a movement direction and a movement amount of the display window from the basic display position, and
the changed display position is a position moved in a movement direction based on the movement direction included in the movement history information, by a movement amount based on the movement amount included in the movement history information, from the basic display position determined by the display instruction.

3. The information processing apparatus according to claim 2, wherein
the processor displays the display window at a position with the smallest amount of edges of a screen which are displayed on the display before the display window is displayed and which are hidden when the display window is displayed, among the changed display position and one neighboring position or a plurality of neighboring positions of the changed display position.

4. The information processing apparatus according to claim 3, wherein
the processor
calculates an index value that
increases as the amount of edges hidden when the display window is displayed increases, and
increases as a distance from the changed display position increases, for each of the changed display position and the one neighboring position or the plurality of neighboring positions of the changed display position, and
displays the display window at a position where the index value is the smallest.

5. The information processing apparatus according to claim 1, wherein
the display window comprises a plurality of types of buttons,
the movement history information includes information indicating a movement direction of the display window from the basic display position and a button operated after a movement, and
when (i) the operator tends to operate a first button after moving the display window in a first movement direction and (ii) the operator tends to operate a second button after moving the display window in a second movement direction, the processor
displays a divided window including the first button at a position moved in the first movement direction from the basic display position based on the movement history information, and
displays a divided window including the second button at a position moved in the second movement direction from the basic display position based on the movement history information.

6. A non-transitory computer readable medium storing a program that causes a computer to execute information processing, the information processing comprising:
receiving a display instruction to display a display window from an operator;
automatically displaying the display window on a display at a basic display position determined according to a predetermined rule, in response to determining that movement history information of a plurality of movement instructions of a display window by the operator does not satisfy a first condition; and
automatically displaying the display window on the display at a changed position that is offset from the basic display position, in response to determining that the movement history satisfies the first condition.

7. An information processing apparatus comprising:
means for
receiving a display instruction to display a display window from an operator;
automatically displaying the display window on a display at a basic display position determined according to a predetermined rule, in response to determining that movement history information of a plurality of movement instructions of a display window by the operator does not satisfy a first condition, and
automatically displaying the display window on the display at a changed position that is offset from the basic display position, in response to determining that the movement history satisfies the first condition.
